(19) United States
(12) Patent Application Publication
(10) Pub. No.: US 2013/0232923 A1
(43) Pub. Date: Sep. 12, 2013

(54) BAG RECYCLER AND HOLDER

(71) Applicant: Gabriel D. Beversluis, Grand Rapids, MI (US)

(72) Inventor: Gabriel D. Beversluis, Grand Rapids, MI (US)

(21) Appl. No.: 13/764,215

(22) Filed: Feb. 11, 2013

Related U.S. Application Data
(60) Provisional application No. 61/608,706, filed on Mar. 9, 2012.

(51) Int. Cl. B65B 67/12; B65F 1/14; A45F 5/00; B65B 43/26; F16M 13/02

(52) U.S. Cl. CPC B65B 67/1216; B65B 43/26; F16M 13/02; A45F 5/00; B65F 1/1415
USPC 53/492; 248/99; 294/143

(57) ABSTRACT

A bag storage apparatus is provided for storing collapsed plastic bags with handle loops and for holding one of the plastic bags in an open position to receive items placed therein. The apparatus includes a body defining a main storage cavity; a secondary panel forming a second rounded shape and attached to a front of the body to define a storage location for collapsed bags in front of the main storage cavity; upper top side edges of the body protruding upwardly and defining crevices adapted to positively engage and retain the loops when an associated one of the plastic bags is held in the open position in the main storage cavity; and the second panel having top and bottom openings for access to any bags stored inside the storage location.

### CROSS-REFERENCE TO RELATED APPLICATION

This application claims priority under 35 U.S.C. §119(e) to, and the benefit of, U.S. Provisional Patent Application No. 61/608,706, entitled “BAG HOLDER,” filed on Mar. 9, 2012, the entire disclosure of which is hereby incorporated by reference.

### BACKGROUND

The present invention relates to an apparatus for recycling and holding bags, and in particular relates to an apparatus particularly adapted to hold plastic bags in a compact easily-accessible location until use, and then hold open a selected bag for reuse, thus facilitating reuse and recycling of the bags. The apparatus is particularly adapted for use with loop-handled polymeric bags such as are commonly used to carry groceries and retail or clothing items.

Lightweight loop-handled plastic bags are widely used to carry consumer products, such as groceries, clothing, and other items purchased in retail stores. There is a tremendous waste created when consumers do not reuse these polymeric bags. An efficient, effective, and aesthetically-pleasing apparatus is desired that is easy and intuitive to use, but that also has sufficient aesthetic appeal to encourage consumers to reuse and recycle “previously-used” bags. Further, improvement is desired in such apparatus to maximize functionality (e.g. ease of use and convenience), minimize material cost, minimize assembly cost, make its attachment intuitive including its positioning in locations for use, and doing so while maintaining optimal aesthetics.

### SUMMARY OF THE PRESENT INVENTION

In one aspect of the present invention, a bag storage apparatus for storing collapsed plastic bags with handle loops and for holding one of the plastic bags in an open position to receive items placed therein, includes a body forming a tubular shape to define a main storage cavity and a secondary panel forming a curvilinear shape and attached to a front of the body to define a storage location for collapsed bags in front of the main storage cavity. The body includes upper side wing sections protruding upwardly and defining crevices therebelow adapted to receivingly engage the handle loops when an associated one of the plastic bags is held in the open position in the main storage cavity.

In another aspect of the present invention, a bag storage apparatus is provided for holding a plastic bag in an open position to receive items placed therein. The apparatus comprises a body forming a tubular shape defining a main storage cavity and defining side wing sections on the body protruding upwardly and defining crevices therebelow adapted to receivingly engage the handle loops when the plastic bag is held in the open position in the main storage cavity, the body including a rear wall with an apertured flange forming a finger-receiving handle and having vertically-open slits on opposite sides of the handle for frictionally engaging and tensioning an upper edge of the plastic bag across the apertured flange.

These and other aspects, objects, and features of the present invention will be understood and appreciated by those skilled in the art upon studying the following specification, claims, and appended drawings.

### BRIEF DESCRIPTION OF DRAWINGS

FIG. 1 is a perspective view showing an apparatus embodying the present invention as installed on a kitchen under-sink cupboard door.

FIGS. 2-3 are a perspective and exploded perspective view of FIG. 1.

FIGS. 4-7 are front, side, rear, and top views of FIG. 3.

FIG. 8 is a perspective view of FIG. 1 showing a crumpled bag being pulled from the storage pocket.

FIG. 9 is a perspective view of FIG. 1 showing the bag being supported for use with its loop handles being secured to notches in sides of the main bag cavity to hold the bag open.

### DETAILED DESCRIPTION OF PREFERRED EMBODIMENTS

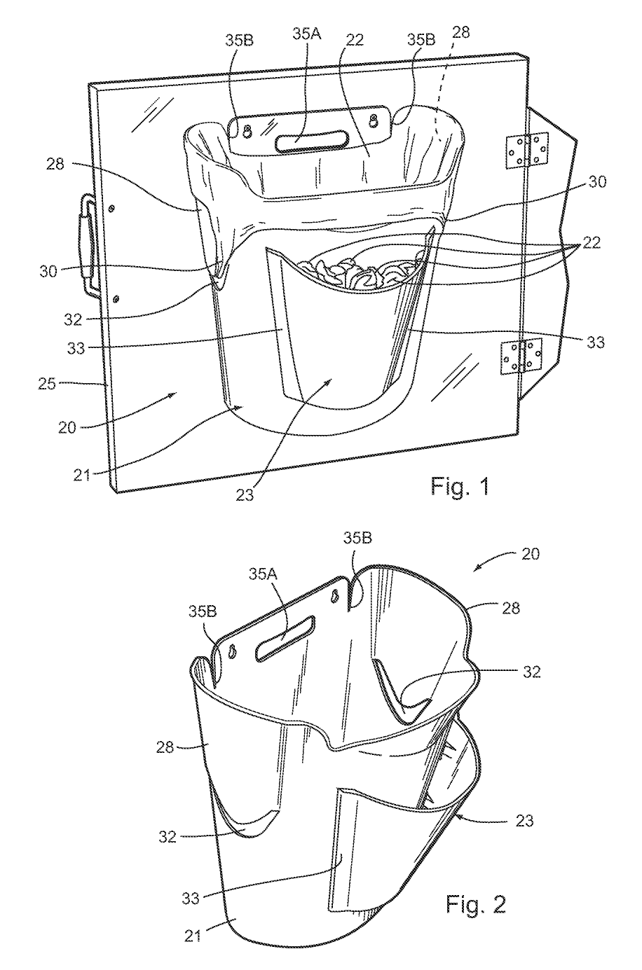

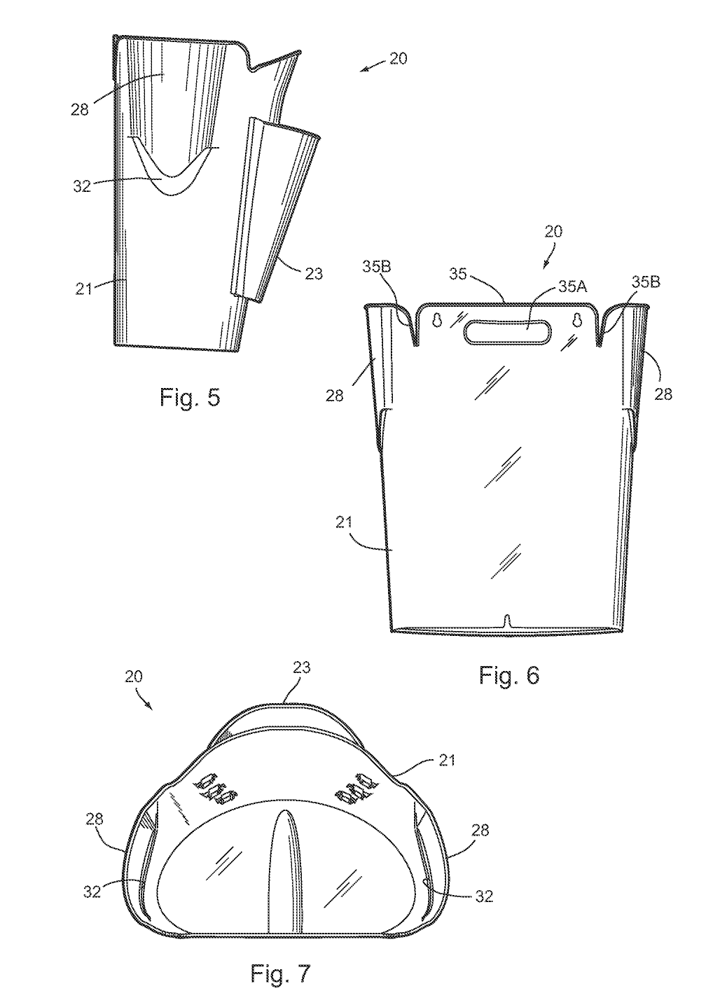

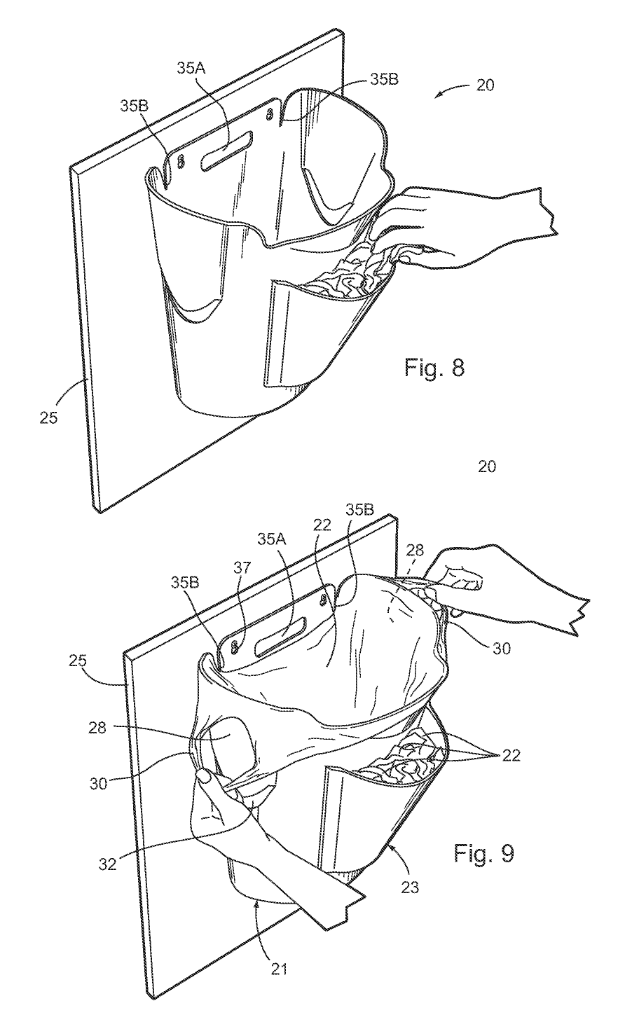

The present apparatus 20 (FIGS. 1-9) is a recycling system for plastic bags that leads to efficient storage and reuse, and also which saves the consumer money. The present apparatus 20 includes a primary body 21 (also called a “primary shell” herein) forming a large bag-holding tubular cavity for holding a bag 22 open to receive trash and/or other material, and a smaller secondary panel 23 (also called a “secondary shell”) attached to a front of the body 21 in a curvilinear shape that forms a smaller bag-holding storage cavity for holding wadded/crumpled bags 22. The apparatus 20 can function as a stand-alone unit, but is particularly adapted for releasable mounting to a hinged cabinet door 25, such as under a kitchen sink (FIG. 1). The apparatus 20 is aesthetically pleasing, but also easy to access and use. By this arrangement, a user can load bags 22 into the holding cavity of secondary shell 23 until needed, and then can easily withdraw individual bags 22 for use in the primary bag-holding cavity of shell 21. It is noted that bags 22 are of the type often used by grocery stores and retail stores, and which are normally thrown away by the end user. By using the present apparatus 20, these bags 22 will be effectively stored until they are used/recycled, thus providing a green and environmentally friendly economic system, and at the same time saving the consumer considerable expense by eliminating the need to purchase specialty garbage bags.

The present apparatus 20 includes an injection molded primary compartment-defining shell/body 21. The shell 21 can be formed by different means, but preferably is injection molded to form an aesthetically pleasing oval with flat-back or obround side wall with integral bottom. The top end of the cavity formed by shell 21 is slight larger than its bottom for aesthetics and functionality. Two wing sections 28 are integrally formed at a top or sides of the body 21, with a notch or side-located crevice 32 formed under the wing sections 28. The wing sections 28 and side-located crevices 32 are shaped to receive and positively/frictionally hold the handle loops 30 of the bags 22 in a manner keeping the bag 22 open in the body 21 with an upper edge of the bag 22 draped over the upper edge of the body 21. A flange 35 extends along an upper edge of a rear of the body 21, and includes an aperture 35A forming a finger handle for conveniently carrying the apparatus 20, and includes spaced-apart back crevices 35B for retaining the bag 22 in the open body 21, as described below.

The wing sections 28 extend upwardly and slightly outwardly from the sides of the body 21 to provide a great modern and aesthetic appearance. Also, the side-located crevices 32 are elongated in a front-to-rear direction and include narrowed tips, thus providing functionality by causing the loop handles 30 of the bag 22 to creep/slide into tight engagement with edges of the body 21, thus causing a top of the bag 22 to pull tight against the body 21. This tends to eliminate gaps between the body 21 and the bag 22 where waste may undesirably fall. The back wall of body 21 also includes the aperture 35A, which forms a convenient finger-receiving handle for carrying the present apparatus 20, and further includes vertically-open back slits 35B with narrowed bottom. The back slits 35B are configured to frictionally retain and tension a rear upper edge of the bag 22, keeping the bag 22 tight against the rear wall so that trash and debris does not fall in between a rear of the bag 22 and the holder 21.

The secondary panel 23 is basically a curvilinear panel attached to a front side of the body 21 to form the secondary holding cavity. The illustrated secondary holding cavity of panel 23 is upwardly open and slightly frustoconically shaped, such that it generally mimics a shape of the body 21. It is contemplated that the secondary panel 23 can include an open bottom as well. By making the secondary panel 23 have a frustoconical/truncate shape (i.e. slightly smaller at its bottom and larger at its top), the secondary panel 23 forms a holding cavity that naturally and securely holds collapsed/crumpled bags 22 in storage, while also making it easy to select and remove a top bag 22 (or bottom bag) for use.

As noted above, the body 21 is generally a “cylindrical” or tubular shape, with an open top and closed bottom, and with a slightly larger diameter top than bottom. The illustrated body 21 is molded as a one-piece formed part and includes a bottom/floor, but it is contemplated that it would be made by other means, such as by forming a flat panel into a cylindrical shape and welding to permanently fix that shape. It is noted that the present body's cylindrical shape is not perfectly “round,” but instead is curved or oval-shaped, with a flat back wall section. This results in structural/engineering/mechanical advantages that help the body 21 maintain its shape based in part on its oval/tubular shape. Also, it allows the body 21 to stably engage the cabinet door for mounting purposes. Because of the tubular shape, the body 21 as formed can have thinner walls while still providing the structural strength to form a solid semi-rigid structure acceptable to consumers. Notably, the cylindrical shape of body 21 allows some minor bending and flexure, which helps the body resist damage and also helps the body 21 perform its intended function of holding (or storing) bags. The illustrated cylindrical shape has a flat rear section 36 for stable engagement with the cabinet door 25, and includes a pair of top keyholes 37 and a bottom keyhole 37 for engaging screws for attachment. It is contemplated that the body could be other shapes, such as square, rectangular, ellipse, tear drop, or other shape if desired, such as for a particular aesthetic look.

The illustrated wing sections 28 are integrally formed atop the sides of the body 21, but it is contemplated that they could be separate curved wing parts attached such as by adhesive, sonic welding, fasteners, or other means. Their position and arcuate shape form the crevice 32 (i.e. elongated horizontal openings) below the sections 28. The wing sections 28 and crevices 32 are configured to securely frictionally receive and hold handle-loops 30 of the bags 22 with a top of the bag 22 generally held taut, thus holding open the bag 22 tight against the side walls of the body during use in the primary cavity 21. It is contemplated that a scope of the present invention includes wing sections 28 having different shapes and sizes. The illustrated wing sections 28 are rounded and curved to match the aesthetics of the body 21, extending slightly outwardly as they extend above a main portion of the body 21.

The ends of the side crevices 32 of the wing sections 28 extend to front and rear portions of the body and include narrowed front and rear tips that provide a more positive gripper for holding the handle loops of a bag 22 in the apparatus 20. The illustrated wing sections 28 have an arcuate shape, which gives them increased stiffness and which adds to strength of the body 21, thus allowing a thinner wall of material to be used. The curve around the back corner of the wing sections 28 is novel in that it is placed and angled specifically to draw the back edge of the bag tight against the cupboard door when the bag handles are pulled into the handle slots/crevices 32. This also draws an upper front edge of the bag over the upper front edge of the shell 21. This arrangement prevents bag gapping and prevents items from falling in between the bag 22 and the body 21 as shown in FIGS. 1-2. This same arrangement causes the same tight no-gap arrangement when the apparatus 20 is free standing.

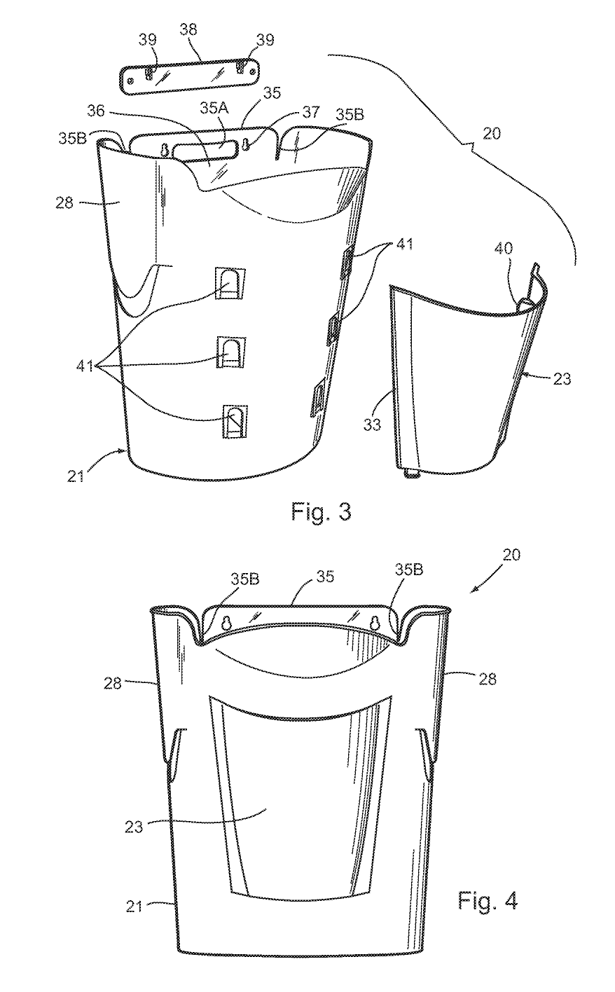

The secondary panel 23 includes attachment flanges 33 attached to the front of the body 21. The flanges 33 are shaped to abuttingly engage the front surface of the body 21 and to aesthetically form the storage cavity of panel 23. When installed, the illustrated secondary panel 23 defines an enlarged top opening and a slightly smaller bottom opening, both of which can be accessed to pull bags out of the storage cavity 23. By forming the secondary panel 23 to a slightly truncated shape at a bottom of the storage cavity, the wadded bags 22 tend to compress and hold themselves within the storage cavity of panel 23 (rather than slip down and out under gravity). Alternatively, it is noted that the material of the secondary panel 23 can be such that it creates enough friction so it assists in retaining bags 22. The material of the secondary panel 23 is preferably the same as for the body 21. As illustrated, the panel 23 includes loops 40 (FIG. 3) along its vertical edges that releasably engage upwardly-extending finger retainers 41 on the body 21. This and the frustoconical/truncated overall shape allows for dense shipment of stacks of the apparatus 20. Alternatively, the panel 23 can be attached by adhesive, sonic welding, fasteners (such as hidden rivets), keyhole and mating protrusion, or other means, or it can be integrally formed and/or permanently attached to the body 21.

A preferred plastic is either polypropylene or polyethylene, and it is contemplated that it can be either virgin material or recycled material or a combination of the two materials. Colors can be as desired, such as white or black or other. Further, the finished product can be painted, printed on, or otherwise covered or coated, such as to provide a wood grain or other design. Material thickness will vary depending on the grade and type of plastic used and draft angle for molded side walls, but for example as illustrated is about 0.070 to 0.120 inches thickness. It is contemplated that preferred dimensions of the body 21 of the apparatus 20 are about 13″ high, 12″ wide, 6.5″ thick (deep) at the base, and 2″ depth for the pouch/secondary panel 23.

It is noted that a modified design could form both body 21 and panel 23 from a single unitary sheet, such as by creating/forming the first cavity 21 from a first “two-thirds” of the sheet, and then folding a remainder of the single sheet reversely around the front to form the second cavity of panel 23 in front of the main cavity of body 21.

The illustrated body 21 (FIG. 3) includes an apertured attachment flange 35 along its top rear edge (and potentially a third flange along its bottom); the attachment flange 35 being located along a relatively flat rear section 36 of the body 21. The flange 35 defines an aperture 35A that can be used as a handle, and vertically-open slits 35B that frictionally engage the bag 22 to hold it open when in the body 21. The flange 35 includes two (or more) key-hole shaped slots 37 with a narrow top portion and wide bottom portion. If a bottom flange 35 is used, it can define an open inverted U-shape or inverted V-shape, so that the apparatus 20 can slip downward onto the bottom screw without having to be accurately aligned with a key-hole slot during installation. By this arrangement, an attachment bracket 38 with headed protrusions 39 (or alternatively screws) (FIG. 3) can be attached to the cabinet door 25 (such as by screws or adhesive), or attached to any surface (e.g. any building wall or cabinet such as in a kitchen or garage, inside or outside, or in any work environment, such as to a bench, furniture, or other support portable or fixed structure). A head of the protrusions 39 is spaced away from the door 25 so that the keyhole slots 37 can be engaged with the headed protrusions 39. The apparatus 20 can then be then lowered, so that a shaft of the protrusions 39 moves into the narrow top portion of the slots 37, thus securely but releasably holding the apparatus 20 on the door 25. The keyhole slots 37 can include a bump or narrowed throat for frictionally retaining the protrusions in the narrow end of the slot 37, if desired.

The present protrusions 39 and slots 37 are designed to allow quick release of the apparatus 20, so that it can be moved to different locations, such as to facilitate easy use for wiping off counters or gathering debris from any location. The aperture 35A can act as a convenient handle when moving and carrying the apparatus 20. Thereafter, the holder can again be quickly and easily reattached to its mounting bracket in a “home” location, such as to a cabinet wall or other vertical support structure. It is contemplated that other means can be used to attach and hold the apparatus 20 on the door 25, such as direct screw-attachment, adhesive, tape, hooks, suction cups, magnets, and other means known in the art. Preferably, three attachments are used to mount the apparatus 20 for stability reasons. However other means can be used, depending on a particular application. For example, a suction cup or magnets could be used for mounting the apparatus 20 to a washer, dryer, refrigerator or tool box. Notably, the present apparatus 20 has a flat bottom, such that it can also be used as a free standing unit.

A shape of the body 21 and the side wing sections 28 causes the bag 22 in the primary cavity to be held open for easy use. Further, their radiused shape allows the apparatus 20 to be used even in tight locations and even if the apparatus 20 has to be positioned next to surface mounted hinges where it would otherwise interfere with that mounting location (such as if it had a rectangular shape of similar size). Still further, the shape of the side wing sections 28 and vertically-open crevices/slits 35B allows for easy removal of a full bag 22 and easy replacement and reinstallation of a new bag 22.

Notably, the present apparatus 20 can be used for recycling and reuse of plastic bags. However, it is not limited to just receiving trash. Instead, it can be used for any trash-receiving operation, as well as for any packaging operation (such as in a retail store).

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A bag storage apparatus for storing collapsed plastic bags with handle loops and for holding one of the plastic bags in an open position to receive items placed therein, comprising:
a body forming a tubular shape defining a main storage cavity;
a secondary panel forming a curvilinear shape and attached to a front of the body to define a storage location for collapsed bags in front of the main storage cavity; and
side wing sections on the body protruding upwardly and defining crevices therebelow adapted to receivingly engage the handle loops when an associated one of the plastic bags is held in the open position in the main storage cavity.

2. A combination including the apparatus of claim 1 and including a selected one of the bags, the selected one bag having two of the handle loops each of a length and shape such that when secured in the crevices, an upper edge of the selected one bag is drawn tight against an upper rear edge of the body with zero gap between the upper rear edge of the body and the upper edge of the selected one bag.

3. The apparatus of claim 1, wherein the upper side wing sections are integrally formed with body.

4. The apparatus of claim 1, wherein the tubular shape defines a truncated frustoconical shape.

5. The apparatus of claim 4, wherein the curvilinear shape of the secondary panel mimics the tubular shape of the body.

6. The apparatus of claim 1, wherein the body includes a flat rear surface.

7. The apparatus of claim 6, wherein the rear surface includes attachment apertures adapted for attachment to a vertical support structure.

8. The apparatus of claim 1, wherein the crevices are elongated in a front-to-rear direction and include narrowed tips.

9. The apparatus of claim 1, including a bracket with attachment holes for attachment to a cabinet wall and forwardly-extending protrusions shaped to releasably engage mating apertures in a rear portion of the body for releasably securing the body to the cabinet wall.

10. The apparatus of claim 1, wherein the body includes an upper rear flange with an aperture therein forming a finger-grip handle.

11. The apparatus of claim 1, wherein the body includes an upper rear flange with upwardly-open vertical slits forming pinch points for holding a rear upper edge of the associated one bag in a tensioned condition.

12. A bag storage apparatus comprising:
a body including a first curvilinear wall defining a main storage cavity and a second curvilinear wall defining a secondary storage cavity in front of the main storage cavity, with the first curvilinear wall having a flat rear wall portion and having curved side wall portions with crevices extending in a fore-aft direction, and with the second curvilinear wall including vertical side edges attached to the first curvilinear wall so that the secondary storage cavity includes a larger top opening and a smaller bottom opening, whereby plastic bags with loop handles can be crumpled and stored in the secondary storage cavity, and whereby a selected one bag can be opened and positioned in the main storage cavity with its loop handles retained in the crevices.

13. A combination including the apparatus of claim 12 and including a selected one of the plastic bags, the body having crevices along opposing sides, and the selected one bag having two of the handle loops each of a length and shape such that when secured in the crevices, an upper edge of the selected one bag is drawn tight against an upper rear edge of the body with zero gap between the upper rear edge of the body and the upper edge of the selected one bag.

14. The apparatus of claim 12, wherein the second curvilinear wall is releasably attached to the first curvilinear wall at vertical side edges of the second curvilinear wall.

15. The apparatus of claim 12, wherein the first curvilinear wall includes wing sections that extend upwardly and outwardly from the crevices.

16. The apparatus of claim 12, wherein the first curvilinear wall defines a truncated frustoconical shape.

17. The apparatus of claim 16, wherein the second curvilinear wall includes a shape mimicking a shape of the first curvilinear wall.

18. The apparatus of claim 12, wherein the first curvilinear wall includes a flat rear surface.

19. The apparatus of claim 18, wherein the rear surface includes attachment apertures adapted for attachment to one of a cabinet door or cabinet wall.

20. The apparatus of claim 12, including a bracket with attachment holes for attachment to a cabinet wall and forwardly-extending protrusions shaped to releasably engage mating apertures in a rear portion of the body for releasably securing the body to the cabinet wall.

21. A bag storage apparatus for holding a plastic bag in an open position to receive items placed therein, comprising:
a body forming a tubular shape defining a main storage cavity and defining side wing sections on the body protruding upwardly and defining crevices therebelow adapted to receivingly engage the handle loops when the plastic bag is held in the open position in the main storage cavity, the body including a rear wall with an apertured flange forming a finger-receiving handle and having vertically-open slits on opposite sides of the handle for frictionally engaging and tensioning an upper edge of the plastic bag across the apertured flange.

22. A method comprising steps of:
providing a bag storage apparatus with a body defining a main storage cavity, and a panel attached to the body and defining a storage location in front of the main storage cavity, the body having fore-aft extending crevices in sides of the body;
storing collapsed plastic bags with handle loops in the storage cavity;
pulling one of the plastic bags from the storage cavity and placing the one plastic bag in an open position in the main storage cavity to receive items placed therein, including positioning the handle loops of the one plastic bag in the crevices.

23. The method defined in claim 20, wherein the step of providing a bag storage apparatus with a body includes forming outwardly-extending wing sections on a top of sides of the body in a location above the crevices.
